(19) United States
(12) Patent Application Publication
(10) Pub. No.: US 2005/0061881 A1
(43) Pub. Date: Mar. 24, 2005

(54) Computerized system and method of conducting an election

(76) Inventor: Francis C. Clancey, Lynnfield, MA (US)

Correspondence Address: Richard C. Litman;LITMAN LAW OFFICE, LTD., P.O. BOX 15035, Arlington, VA, 22215, US

(21) Appl. No.: 10/981,793

(22) Filed: Nov. 5, 2004

Related U.S. Application Data
(63) Continuation-in-part of application No. 10/745,667, filed on Dec. 29, 2003.
(60) Provisional application No. 60/475,909, filed on Jun. 5, 2003.

(51) Int. Cl. G06F 17/60

(52) U.S. Cl. 235/386

(57) ABSTRACT

A computerized system and method of conducting an election by voters with votes for candidates in the election. This method comprises the steps of providing a computer to receive the votes from the voters for the candidates, tallying the votes for each of the candidates throughout a jurisdiction, calculating a percentage of the votes for each of the candidates by dividing the number of votes cast for each of the candidates by the number of votes cast in the jurisdiction, awarding each of the candidates a proportional percentage of votes that correspond to the percentage of the votes for each of the candidates and declaring the candidate with the most votes a winner of the election.

### CROSS-REFERENCE TO RELATED APPLICATIONS

This application is a continuation-in-part of pending application Ser. No. 10/745,667, filed Dec. 29, 2003, which claims the benefit of U.S. Provisional Patent Application Ser. No. 60/475,909, filed Jun. 5, 2003.

### BACKGROUND OF THE INVENTION

1. Field of the Invention

The present invention relates to a computerized system and method of conducting an election. More particularly, the computerized system and method can also be used to conduct an election or survey (i.e. a political election, a stockholder's election or an election within an organization).

2. Description of the Related Art

The principle of “one person, one vote” has long been a benchmark that is strived for, but is often not achieved in an election. For example, under our U.S. presidential electoral system, a candidate who receives the largest percentage of popular votes in a state generally receives all of that state's electoral votes. As a result, the segment of the population that voted for the less popular candidate(s) is effectively ignored. That is, since the winning candidate receives all of the electoral votes, all votes cast for the losing candidate(s) have no effect on the electoral process. This has lead to desperate struggles by presidential candidates to win the states with the most electoral votes, knowing full well that 11 such states often decide the outcome of an election. Moreover, once the “magic number” of electoral votes is achieved (i.e. 270), voting results in the remaining states become a moot point. Consequently, large numbers of votes have no effect on the outcome of an election. In addition, election results can be challenged in court when the popular vote for each candidate is too close to call, because “the winner takes all” and the loser, despite having nearly the same number of votes, gets nothing.

This principle can also pertain to elections that are held within an organization such as a stockholders' meeting or any type of election or pole. In a closely contested election, this principle can determine which participants can win or lose an election. With modern technology, such as the computer, many elections can be quickly and accurately determined, whether the election is conducted on a national scale or on a much smaller scale within a survey or research study.

None of the above inventions and patents, taken either singly or in combination, is seen to describe the instant invention as claimed. Thus a computerized system and method of conducting an election solving the aforementioned problems is desired.

### SUMMARY OF THE INVENTION

The invention is a computerized system and method of conducting an election by voters with votes for candidates in the election. This method comprises the steps of providing a computer to receive the votes from the voters for the candidates, tallying the votes for each of the candidates throughout a jurisdiction, calculating a percentage of the votes for each of the candidates by dividing the number of votes cast for each of the candidates by the number of votes cast in the jurisdiction, awarding each of the candidates a proportional percentage of votes that correspond to the percentage of the votes for each of the candidates and declaring the candidate with the most votes a winner of the election.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an overview flow chart depicting the overall method of conducting an election.

FIG. 2 is an overview of the computerized system for conducting an election.

FIG. 3 is an illustration of an electoral map of the United States during the year 2000 U.S. presidential election.

Similar reference characters denote corresponding features consistently throughout the attached drawings.

### DETAILED DESCRIPTION OF THE PREFERRED EMBODIMENT

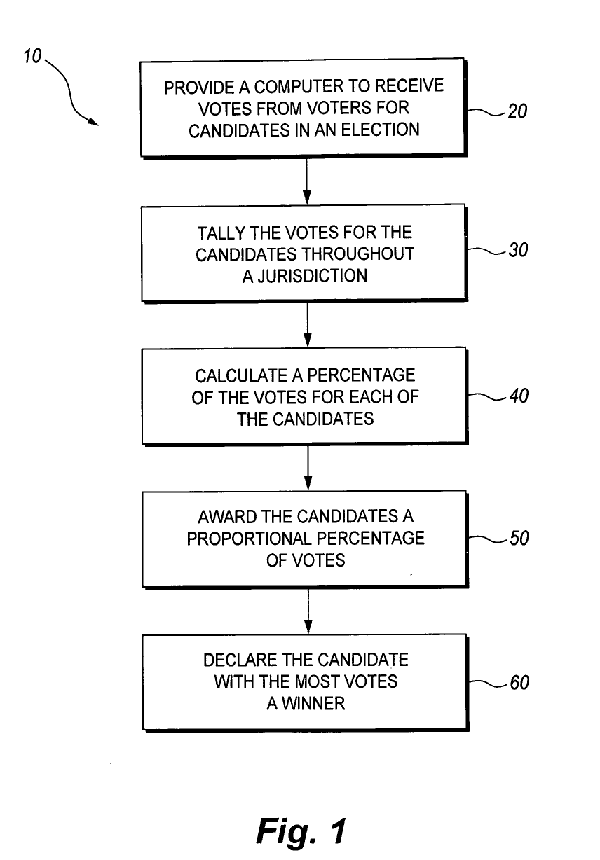

The invention is a computerized method of conducting an election by voters with votes for candidates in an election 10, comprising the steps of providing a computer to receive the votes from the voters for the candidates 20, tallying the votes for each of the candidates throughout a jurisdiction 30, calculating a percentage of the votes for each of the candidates 40 by dividing the number of votes cast for each of the candidates by the number of votes cast in the jurisdiction, awarding each of the candidates a proportional percentage of votes that correspond to the percentage of the votes for each of the candidates 50 and declaring the candidate with the most votes a winner of the election 60. These steps are outlined in FIG. 1.

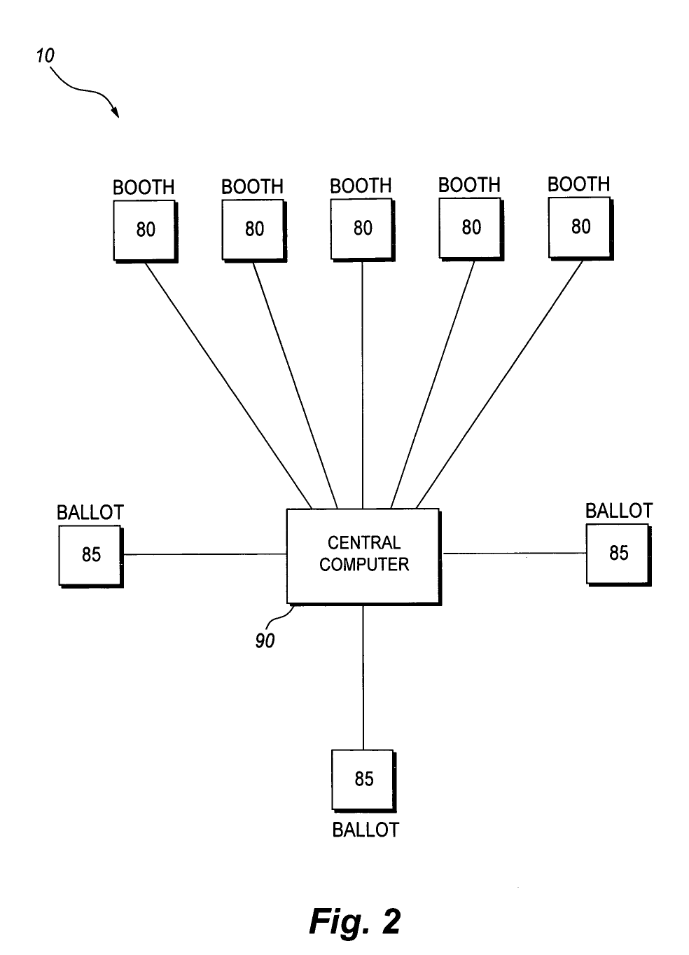

FIG. 2 illustrates an overview of a computerized system for conducting an election 70. The computerized system for conducting an election 70 comprises a plurality of voting booths 80 and a centralized computer 90 that collects and tabulates the votes from the voters in the voting booths 80. Votes can also be tabulated by gathering voting ballots and including them in the calculations done in the centralized area 90. There are several embodiments of the computerized system for conducting an election 70. These embodiments include political elections, corporate elections, stockholders' elections and surveys such as marketing surveys.

Using an example, in the context of the 2000 U.S. presidential election, candidates will receive a certain percentage of the popular vote in each of the fifty states. Each candidate's percentage of the popular vote will then be converted into electoral votes by multiplying the percentage of popular vote received by the total number of electoral votes possessed by the state in question. This process is repeated for every state.

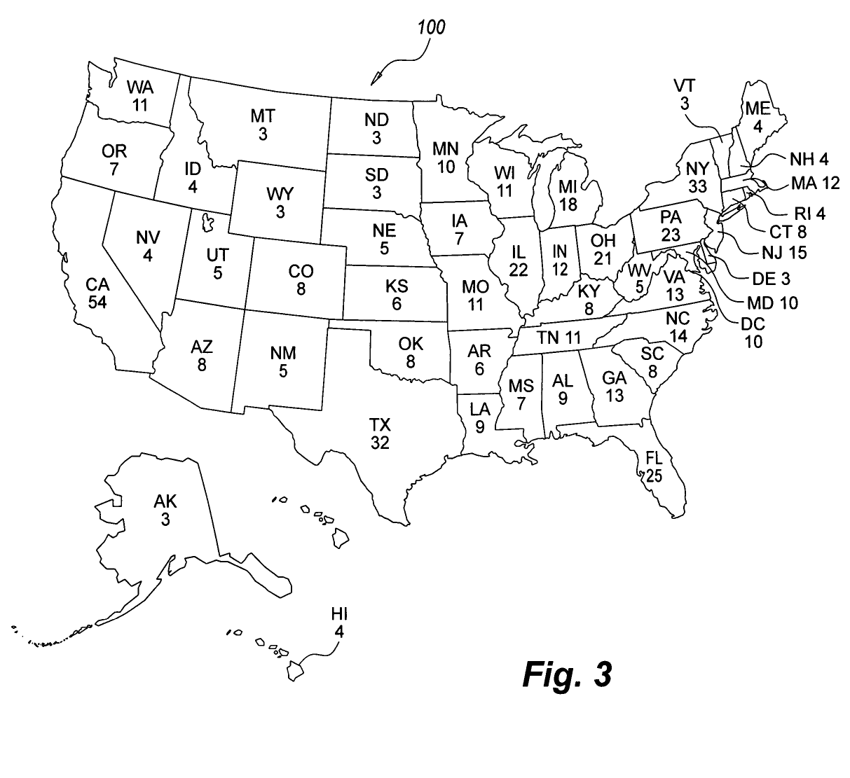

FIG. 3 illustrates an electoral map of the United States 20, which indicates the number of electoral votes possessed by each state for purposes of the 2000 U.S. Presidential Election. For example, in the last election, Vice President Gore received fifty four percent (54%) of all votes cast in the state of California. Under the method herein described, this percentage would be converted to Vice-President Gore's fair share of California's fifty-four electoral votes, which would be 29.16 electoral votes (54×0.54). Then Governor, George W. Bush, received forty-two (42%) of all votes cast. His share of electoral votes would therefore have been 22.68 electoral votes (54×0.42). Candidate Ralph Nader received four percent (4%) of the popular vote and his share of electoral votes would have been 2.16. When added together, the electoral votes apportioned to each candidate equal the total number of electoral votes assigned to the state:

| | |
|---|---|
| A. Gore | 29.16 |
| G. Bush | 22.68 |
| R. Nader | 2.16 |
| Total | 54.00 |

The four remaining candidates, (Buchanan, Browne, Phillips and Hagelin) failed to win enough votes to qualify for a percentage of California's electoral votes. Had this method been implemented in the last presidential election, the results could be represented as follows:

| Total | State's | | | | | | | |
|---|---|---|---|---|---|---|---|---|
| Votes Cast | Electoral | | | | | | | |
| By State | Votes | Bush | Gore | Nader | Buchanan | Browne | Phillips | Hagelin |
| California | 54 | 42% | 54% | 0.04% | 0.0% | 0.0% | 0.0% | 0.0% |
| 10,679,577 | | 22.68 | 29.16 | 2.16 | 0 | 0 | 0 | 0 |
| Illinois | 22 | 43% | 55% | 0.02% | 0.0% | 0.0% | 0.0% | 0.0% |
| 4,741,748 | | 9.46 | 12.10 | 0.44 | 0 | 0 | 0 | 0 |

Voting statistics from the remaining 48 states would have yielded the following final results:

| | | | | | | | | |
|---|---|---|---|---|---|---|---|---|
| Total of | 537.96 | 260.29 | 258.92 | 14.95 | 1.98 | 1.68 | 0.14 | 0.0 |
| all 50 | | | | | | | | |
| States. | | | | | | | | |
| 103,715,797 | | | | | | | | |

There is a discrepancy of 0.04% due to voters in the state of Nevada casting a total of 608,899 votes, of which 3,315 voters did not vote for any of the seven candidates. Note that this is 0.016 or 0.04 of the total ballots cast and that the state of Nevada has an award of 4 electoral votes.

In this way, every vote cast contributes to the selected candidate's total electoral votes. This method stands in stark contrast to the present method in which millions of votes have no effect on electoral votes (e.g. in California, the 4,437,557 votes for Bush produced no electoral votes for him).

Furthermore, no constitutional amendment would be necessary in order to implement this system and method. There is no constitutional requirement that all of a state's electoral votes be awarded to the candidate with the greatest share of the popular vote. In fact, two states (Maine and Nebraska) award only two electoral votes to the winning candidate, with the rest of the electoral votes distributed according to the winner of each congressional district in the state. The Constitution requires only that each state appoint a number of electors equaling the total number of congressmen (senators and representatives) from that state, and that such electors vote for the President and the Vice-President. Accordingly, the states can decide for themselves whether to implement the method herein discussed.

It is to be understood that the present invention is not limited to the embodiments described above, but encompasses any and all embodiments within the scope of the following claims.

1. A computerized method of conducting an election by voters with votes for candidates in the election, comprising the steps of:
providing a computer to receive the votes from the voters for the candidates;
tallying the votes for each of the candidates throughout a jurisdiction;
calculating a percentage of the votes for each of the candidates by dividing the number of votes cast for each of the candidates by the number of votes cast in the jurisdiction;
awarding each of the candidates a proportional percentage of votes that correspond to the percentage of the votes for each of the candidates; and
declaring the candidate with the most votes a winner of the election.

2. The method according to claim 1, wherein the election is a political election.

3. The method according to claim 1, wherein the election is a corporate election.

4. The method according to claim 1, wherein the election is a stockholders' election.

5. The method according to claim 1, wherein the election is a survey.

6. The method according to claim 5, wherein the election is a marketing survey.

7. A computerized system for conducting an election, comprises:
a plurality of voting booths for voters to cast their votes;
a plurality of voting ballots for voters to cast their votes; and
a centralized computer that collects and tabulates the votes from the plurality of voting booths and the plurality of voting ballots.

8. The system according to claim 7, wherein the election is a political election.

9. The method according to claim 7, wherein the election is a corporate election.

10. The method according to claim 7, wherein the election is a stockholders' election.

11. The method according to claim 7, wherein the election is a survey.

12. The method according to claim 11, wherein the election is a marketing survey.
